(19) United States
(12) Patent Application Publication
(10) Pub. No.: US 2023/0395850 A1
(43) Pub. Date: Dec. 7, 2023

(54) LITHIUM-ION BATTERY ELECTROLYTE AND LITHIUM-ION BATTERY

(71) Applicant: CPC CORPORATION, TAIWAN, Kaohsiung City (TW)

(72) Inventor: JEN-HSIEN HUANG, Kaohsiung City (TW)

(21) Appl. No.: 17/886,483

(22) Filed: Aug. 12, 2022

(30) Foreign Application Priority Data
Jun. 2, 2022 (TW) 111120638

(51) Int. Cl. H01M 10/0567; H01M 10/0525; H01M 10/0569; H01M 10/0568; H01M 4/587; H01M 4/525; H01M 4/505

(52) U.S. Cl. CPC H01M 10/0567; H01M 10/0525; H01M 10/0569; H01M 2300/0037; H01M 4/587; H01M 4/525; H01M 4/505; H01M 10/0568

(57) ABSTRACT

A lithium-ion battery electrolyte is provided. The lithium-ion battery electrolyte comprises a lithium salt, a non-aqueous solvent and an additive; wherein the additive has a structure of formula (1) below:

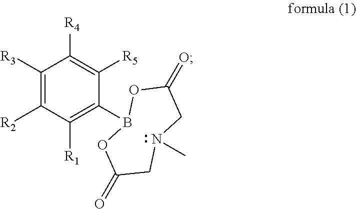

wherein, R₁, R₂, R₃, R₄ and R₅ are each independently selected from hydrogen, fluorine or chlorine. By using the lithium-ion battery electrolyte to which the aforementioned additive is added and the lithium-ion battery, an effective passivation film (CEI film) can be formed, and the cycle life of the battery can be increased.

### CROSS-REFERENCE TO RELATED APPLICATION

This non-provisional application claims priority under 35 U.S.C. § 119(a) on Patent Application No(s).111120638 filed in Taiwan, R.O.C. on Jun. 2, 2022, the entire contents of which are hereby incorporated by reference.

### BACKGROUND OF THE INVENTION

### 1. Field of the Invention

The present invention relates to a lithium-ion battery electrolyte and a lithium-ion battery and, in particular, an electrolyte suitable for use in high voltage lithium-ion batteries.

### 2. Description of the Related Art

In the secondary battery, because the lithium-ion battery has the competitive advantage of high operating voltage and high electric capacity, it has been widely used in many electronic products and electric or hybrid energy-saving vehicles, etc.

The positive electrode material mainly used in lithium-ion batteries includes LiCoO₂, LiMn₂O₄, LiNiO₂ and LiFePO₄ all the time. The average working voltage of these positive electrode materials is lower than 4.0 V (vs. Li/Li+). In addition, for the aforementioned positive electrode material, someone proposes an electrolyte additive formulation, which includes an ionic conductor (such as LiAlTi(PO₄)₃, LiFeTi(PO₄)₃ or LiCrTi(PO₄)₃) and a compound having a maleimide structure to serve as a conductive electrolyte additive.

In addition, in order to improve the power density of lithium-ion batteries, in recent years, scientists have devoted themselves to the development of positive electrode materials with high working voltage, such as LiNiVO₄ (4.8 V), LiNi_{0.5}Mn_{1.5}O₄ (4.7 V), LiCrₓMn₂₋ₓO₄ (4.9 V), LiNiPO₄ (5.2 V), etc., wherein the average working voltages are shown in parentheses.

### BRIEF SUMMARY OF THE INVENTION

However, no electrolyte additives have been developed for use in positive electrode materials capable of high operating voltages. So far, the lithium-ion battery technology with high working voltage is not very mature, mainly due to the poor cycle life performance of the battery. The present inventors believe that this may be affected by the following factors: (1) the stability of the positive electrode material itself; (2) the stability of the passivation film; and (3) the electrolyte.

Next, in terms of the reasons for the poor cycle life of lithium-ion batteries with high working voltage due to the electrolyte, it is because the electrolytes currently on the market are based on carbonate-based solvents. However, the stable working voltage of the carbonate-based electrolyte is less than 4.8 V, so generally the carbonate-based electrolyte is not suitable for battery systems with high working voltage (above 4.8 V). In addition, as mentioned above, the electrolyte is an important factor affecting the cycle life of the battery, so the development of lithium-ion batteries with high working voltage must be based on the electrolyte with high voltage resistance.

In view of the current development trend of lithium-ion batteries toward high energy density, the development of positive electrode materials will gradually focus on the development of high-voltage positive electrode materials. However, the lithium-ion battery is prone to cracking of the electrolyte under the condition of high voltage, resulting in poor cycle life of the lithium-ion battery, so there is room for further improvement.

In order to solve the problems mentioned above, a lithium-ion battery electrolyte of one aspect of the present invention comprises: a lithium salt, a non-aqueous solvent and an additive; wherein the additive has a structure of formula (1) below:

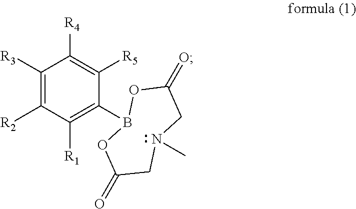

wherein, R₁, R₂, R₃, R₄ and R₅ are each independently selected from hydrogen, fluorine or chlorine.

In one embodiment, the formula (1) is

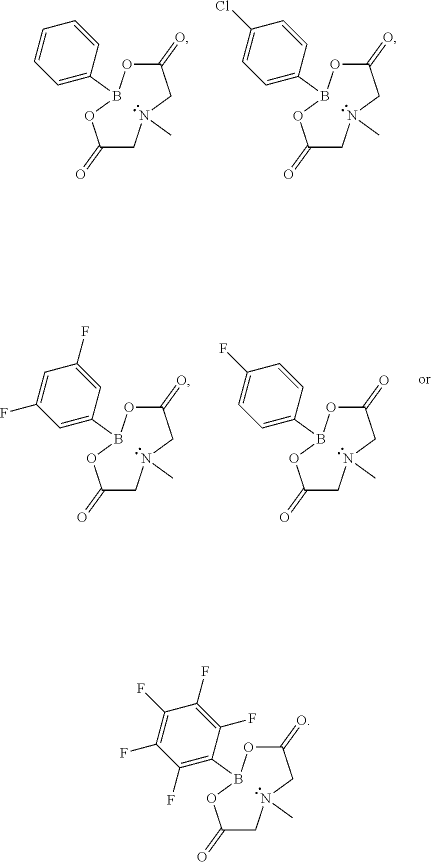 [SMILES: CN1CC(=O)OB(c2ccccc2)OC(=O)C1 ; CN1CC(=O)OB(c2ccc(Cl)cc2)OC(=O)C1 ; CN1CC(=O)OB(c2cc(F)cc(F)c2)OC(=O)C1 ; CN1CC(=O)OB(c2ccc(F)cc2)OC(=O)C1 ; "or" ; CN1CC(=O)OB(c2c(F)c(F)c(F)c(F)c2F)OC(=O)C1]

In one embodiment, a weight percentage of the additive in the lithium-ion battery electrolyte ranges from 0.01% to 3%.

In one embodiment, the lithium salt is selected from the group consisting of lithium hexafluorophosphate (LiPF₆), lithium tetrafluoroborate (LiBF₄), lithium bisoxalatoborate (LiBOB), lithium bis(trifluoromethylsulfonyl)amide (LiTFSI), lithium bisfluorosulfonylimide (LiFSI) and a combination thereof.

In one embodiment, the non-aqueous solvent includes a cyclic carbonate-based solvent and a linear carbonate-based solvent; the cyclic carbonate-based solvent is selected from the group consisting of ethylene carbonate (EC), propylene carbonate (PC), fluoroethylene carbonate (FEC) and a combination thereof; and the linear carbonate-based solvent is selected from the group consisting of dimethyl carbonate (DMC), diethyl carbonate (DEC), ethyl methyl carbonate (EMC), 1,2-difluoroethylene carbonate (DFEC), bis(2,2,2-trifluoroethyl)carbonate (FEMC) and a combination thereof.

In order to solve the problems mentioned above, a lithium-ion battery of one aspect of the present invention comprises: a positive electrode; a negative electrode; a separator disposed between the positive electrode and the negative electrode; and the lithium-ion battery electrolyte described above.

In one embodiment, a positive active material of the positive electrode is selected from the group consisting of LiNiVO₄, LiNi_{0.5}Mn_{1.5}O₄, LiCrₓMn₂₋ₓO₄, LiNiPO₄ and a combination thereof; and a negative active material of the negative electrode is at least one selected from an artificial graphite, a natural graphite and a silicon-carbon composite material composed of Si/SiOₓ (wherein 1<x<2) and graphite.

One aspect of the present invention was made in view of the above-mentioned conventional problems, and an object thereof is to provide a compound represented by the aforementioned formula (1) as an electrolyte additive. In the structure of formula (1), a phenyl group containing various substituents (e.g., hydrogen, chlorine or fluorine) is introduced into the boron. The inventors of the present invention found that if the high-voltage lithium-ion battery contains the electrolyte additive in the electrolyte, the electrolyte additive can be cracked during the charging and discharging process to form a dense and stable cathode electrolyte interface (CEI) film as well as an uniformly coated cathode electrode surface.

Specifically, when the battery is charged and discharged, the electrolyte additive produces an oxidative electrochemical reaction at the positive end, and before the electrolyte (such as a carbonate-based solvent) and a lithium salt undergo a cracking reaction, the electrolyte additive will first crack to produce the CEI film. The CEI film is an alkali metal ion conductor/electronic insulator, so it can prevent the electrons from reacting with the electrolyte, thereby preventing the cracking of the electrolyte caused by high voltage.

Another aspect of the present invention provides a lithium-ion battery electrolyte and a lithium-ion battery, which use the aforementioned electrolyte additive. In addition, by using the lithium-ion battery electrolyte and lithium-ion battery, both of which are added with the aforementioned electrolyte additive, an effective passivation film (CEI film) can be formed, so as to increase the cycle life of the battery.

### BRIEF DESCRIPTION OF THE DRAWINGS

FIG. 1 is the ¹H NMR (400 MHz) spectrum of the additive (1) of the present invention.

FIG. 2 is the ¹H NMR (400 MHz) spectrum of the additive (2) of the present invention. FIG. 3 is the ¹H NMR (400 MHz) spectrum of the additive (3) of the

present invention.

FIG. 4 is the ¹H NMR (400 MHz) spectrum of the additive (4) of the present invention.

FIG. 5 is the ¹H NMR (400 MHz) spectrum of the additive (5) of the present invention.

FIG. 6 is the ¹³C NMR (101 MHz) spectrum of the additive (1) of the present invention. FIG. 7 is the ¹³C NMR (101 MHz) spectrum of the additive (2) of the present invention.

FIG. 8 is the ¹³C NMR (101 MHz) spectrum of the additive (3) of the present invention.

FIG. 9 is the ¹³C NMR (101 MHz) spectrum of the additive (4) of the present invention.

FIG. 10 is the ¹³C NMR (101 MHz) spectrum of the additive (5) of the present invention.

FIG. 11A is the high resolution mass spectrum (HRMS) of the additive (1) of the present invention.

FIG. 11B is the high resolution mass spectrum (HRMS) of the additive (1)

of the present invention.

FIG. 12A is the HRMS of the additive (2) of the present invention.

FIG. 12B is the HRMS of the additive (2) of the present invention.

FIG. 13A is the HRMS of the additive (3) of the present invention.

FIG. 13B is the HRMS of the additive (3) of the present invention.

FIG. 14A is the HRMS of the additive (4) of the present invention.

FIG. 14B is the HRMS of the additive (4) of the present invention.

FIG. 15A is the HRMS of the additive (5) of the present invention.

FIG. 15B is the HRMS of the additive (5) of the present invention.

FIG. 16 is a cycle life test of 250 charge-discharge cycles when the batteries of Test Examples 1 to 6 of the present invention are charged and discharged at a current of 0.5 C.

FIG. 17 is a graph showing the charging and discharging curves of the battery of Test Example 4 of the present invention at the 1st and 250th charge-discharge cycles.

FIG. 18 is a graph showing the charging and discharging curves of the battery of Test Example 6 of the present invention at the 1st and 250th charge-discharge cycles.

FIG. 19 is a cycle life test of 100 charge-discharge cycles when the batteries of Test Examples 7 to 11 of the present invention are charged and discharged at a current of 3 C.

### DETAILED DESCRIPTION OF THE INVENTION

### Electrolyte Additive (Also Referred to as Additive)

The specific aspects of the additive of the present invention can be shown in Table 1 below.

TABLE 1

| Electrolyte additive | Chemical structure | Short name |
|---|---|---|
| 6-methyl-2-phenyl-1,3,6,2- dioxazaborocane-4,8-dione (MPDBD) | 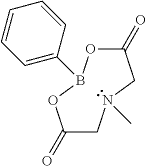 [SMILES: CN1CC(=O)OB(c2ccccc2)OC(=O)C1] | Additive (1) (MPDBD) |
| 2-(4-chlorophenyl)- 6-methyl-1,3,6,2- dioxazaborocane-4,8-dione (CMDBD) | 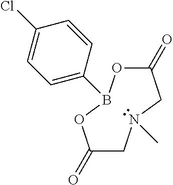 [SMILES: CN1CC(=O)OB(c2ccc(Cl)cc2)OC(=O)C1] | Additive (2) (CMDBD) |
| 2-(4-fluorophenyl)- 6-methyl-1,3,6,2- dioxazaborocane-4,8-dione (FMDBD) | 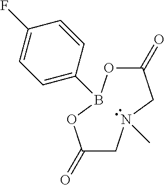 [SMILES: CN1CC(=O)OB(c2ccc(F)cc2)OC(=O)C1] | Additive (3) (FMDBD) |
| 2-(3,5-difluorophenyl)- 6-methyl-1,3,6,2- dioxazaborocane-4,8-dione (DFDBD) | 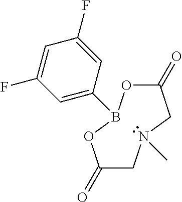 [SMILES: CN1CC(=O)OB(c2cc(F)cc(F)c2)OC(=O)C1] | Additive (4) (DFDBD) |
| 6-methyl-2- (perfluorophenyl)-1,3,6,2- dioxazaborocane-4,8-dione (PFDBD) | 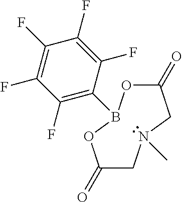 [SMILES: CN1CC(=O)OB(c2c(F)c(F)c(F)c(F)c2F)OC(=O)C1] | Additive (5) (PFDBD) |

### Synthesis of Electrolyte Additives

### Synthesis Example 1 Synthesis of Additive (1)

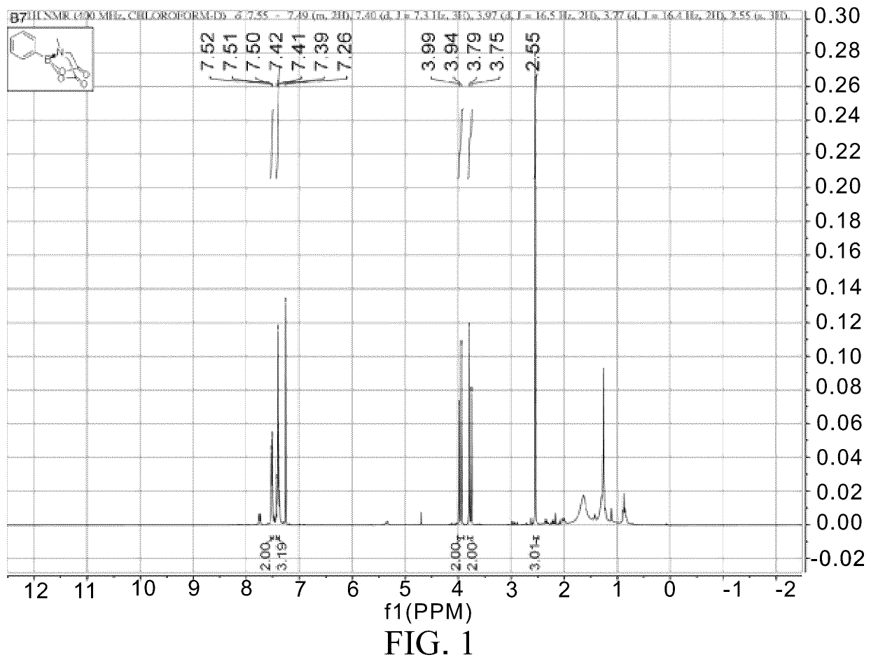

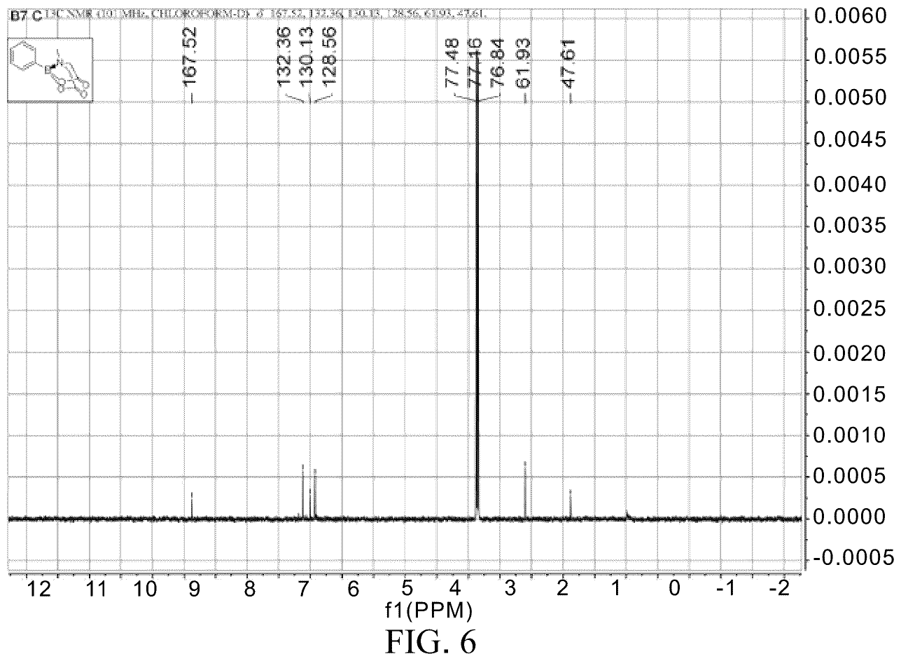

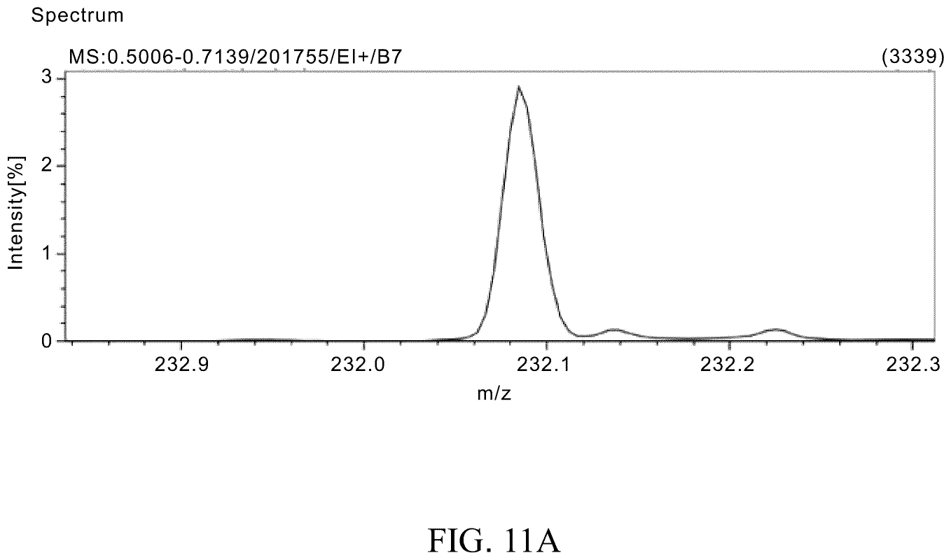

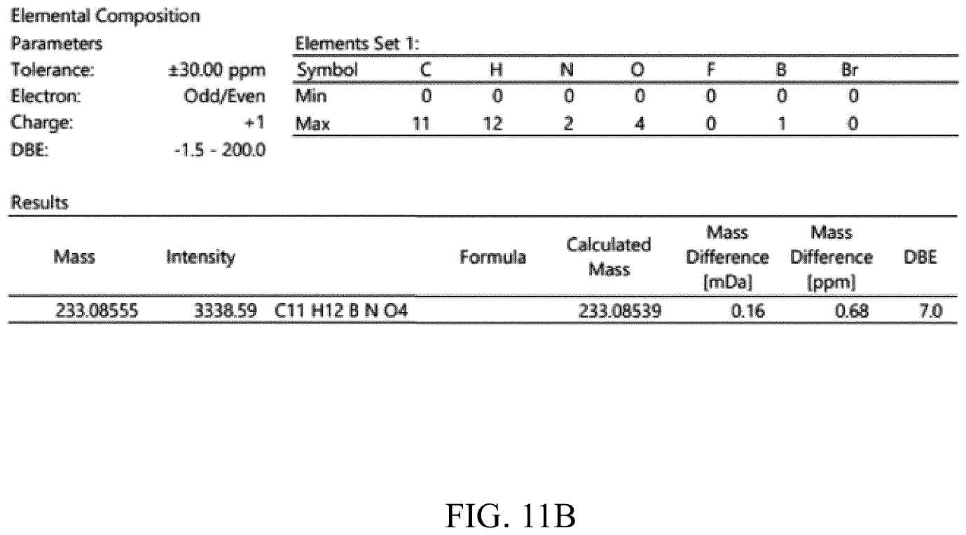

Phenylboronic acid (1.0 equiv.) and N-methyliminodiacetic acid (3.0 equiv.) were placed in a round-bottom flask, 30 ml of a mixed solution of toluene/dimethylsulfoxide (1:0.1 by volume) was used as the reaction solvent, and the molecular sieve (molecular sieve 4 Å, CAS NO.70955-01-0) was added. Next, the mixture was heated under reflux at 120° C. and stirred for 18 hours. After the reaction was cooled to room temperature, the mixture was filtered through molecular sieves and extracted with ethyl acetate and aqueous sodium chloride solution for several times, and then anhydrous magnesium sulfate was added to remove water. After filtering off anhydrous magnesium sulfate, the initial product was obtained by concentration under reduced pressure (40° C. under vacuum). After about 2˜4 mL (for the consumption of milligram-level product) of acetone was added to the aforementioned initial product and then n-hexane was slowly dripped in, it can be observed that the junction of the two solutions appeared turbid. After standing for a period of time, it can be found that crystallization was precipitated. The solvent was removed by gravity filtration or pipette suction, and the final product additive (1) (MPDBD) can be obtained. The synthesis of additive (1) can be identified by NMR spectroscopy and HRMS mass spectroscopy. Please refer to FIGS. 1, 6 and 11A, 11B.

### Synthesis Example 2 Synthesis of Additive (2)

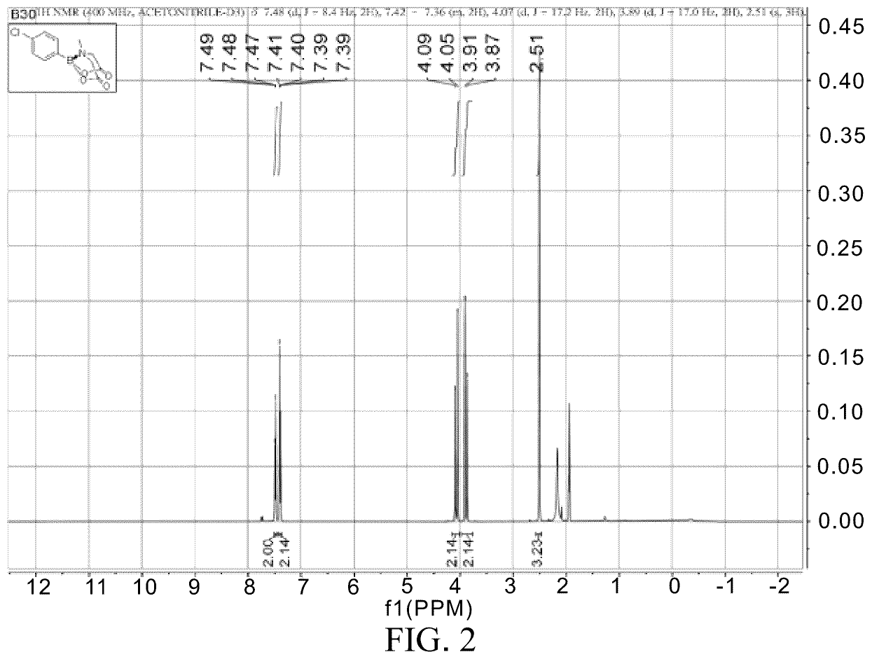

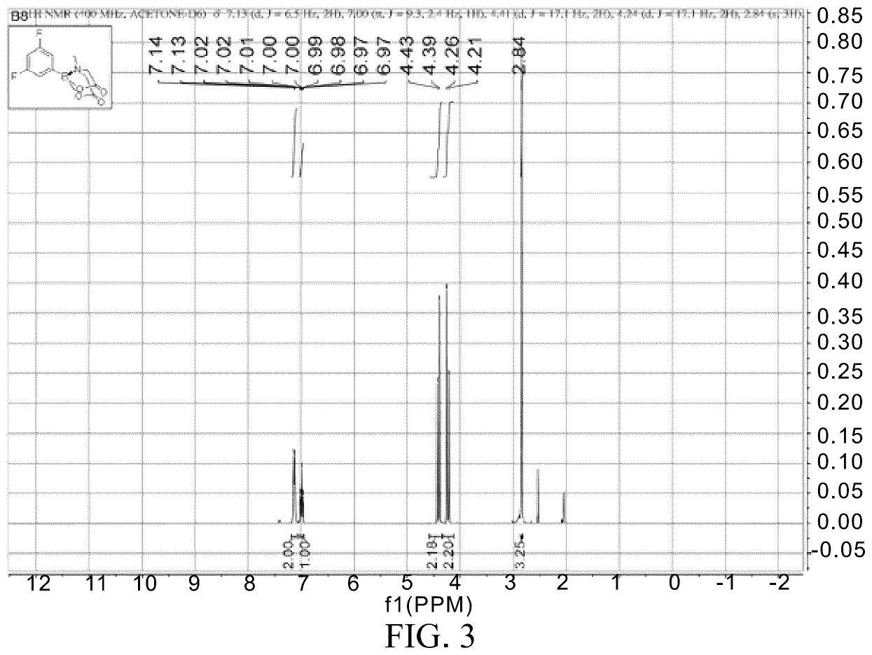

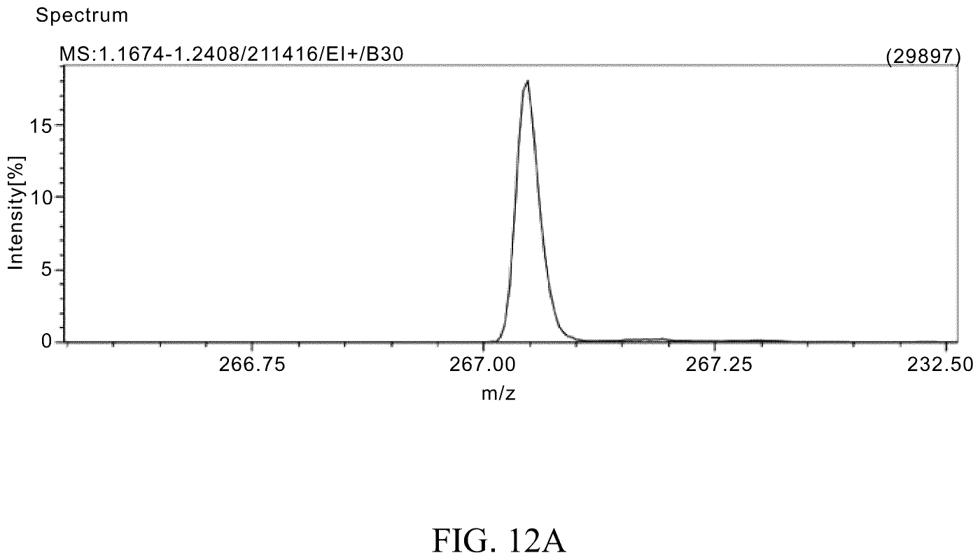

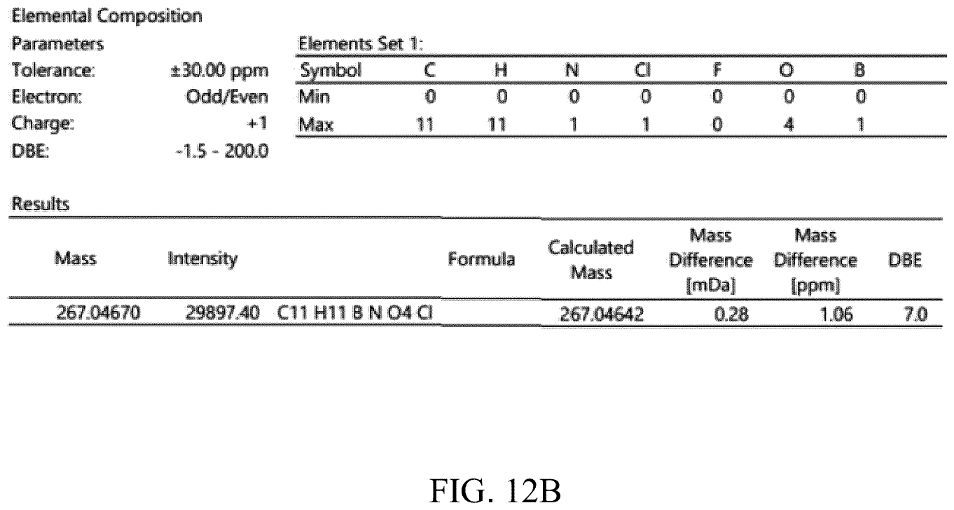

4-chlorophenylboronic acid (1.0 equiv.) and N-methyliminodiacetic acid (3.0 equiv.) were placed in a round-bottom flask, 30 ml of a mixed solution of toluene/dimethylsulfoxide (1:0.1 by volume) was used as the reaction solvent, and the molecular sieve (molecular sieve 4 Å, CAS NO.70955-01-0) was added. Next, the mixture was heated under reflux at 120° C. and stirred for 18 hours. After the reaction was cooled to room temperature, the mixture was filtered through molecular sieves and extracted with ethyl acetate and aqueous sodium chloride solution for several times, and then anhydrous magnesium sulfate was added to remove water. After filtering off anhydrous magnesium sulfate, the initial product was obtained by concentration under reduced pressure (40° C. under vacuum). After about 2˜4 mL (for the consumption of milligram-level product) of acetone was added to the aforementioned initial product and then n-hexane was slowly dripped in, it can be observed that the junction of the two solutions appeared turbid. After standing for a period of time, it can be found that crystallization was precipitated. The solvent was removed by gravity filtration or pipette suction, and the final product additive (2) (CMDBD) can be obtained. The synthesis of additive (2) can be identified by NMR spectroscopy and HRMS mass spectroscopy. Please refer to FIGS. 2, 7 and 12A, 12B.

### Synthesis Example 3 Synthesis of Additive (3)

4-fluorophenylboronic acid (1.0 equiv.) and N-methyliminodiacetic acid (3.0 equiv.) were placed in a round-bottom flask, 30 ml of a mixed solution of toluene/dimethylsulfoxide (1:0.1 by volume) was used as the reaction solvent, and the molecular sieve (molecular sieve 4 Å, CAS NO.70955-01-0) was added. Next, the mixture was heated under reflux at 12° C. and stirred for 18 hours. After the reaction was cooled to room temperature, the mixture was filtered through molecular sieves and extracted with ethyl acetate and aqueous sodium chloride solution for several times, and then anhydrous magnesium sulfate was added to remove water. After filtering off anhydrous magnesium sulfate, the initial product was obtained by concentration under reduced pressure (40° C. under vacuum). After about 2˜4 mL (for the consumption of milligram-level product) of acetone was added to the aforementioned initial product and then n-hexane was slowly dripped in, it can be observed that the junction of the two solutions appeared turbid. After standing for a period of time, it can be found that crystallization was precipitated. The solvent was removed by gravity filtration or pipette suction, and the final product additive (3) (FMDBD) can be obtained. The synthesis of additive (3) can be identified by NMR spectroscopy and HRMS mass spectroscopy. Please refer to

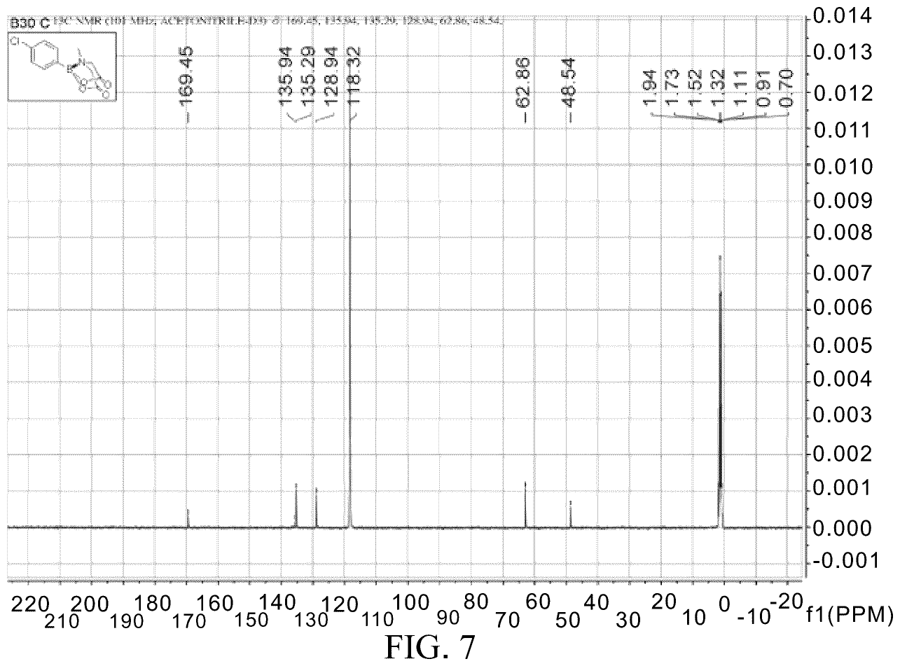

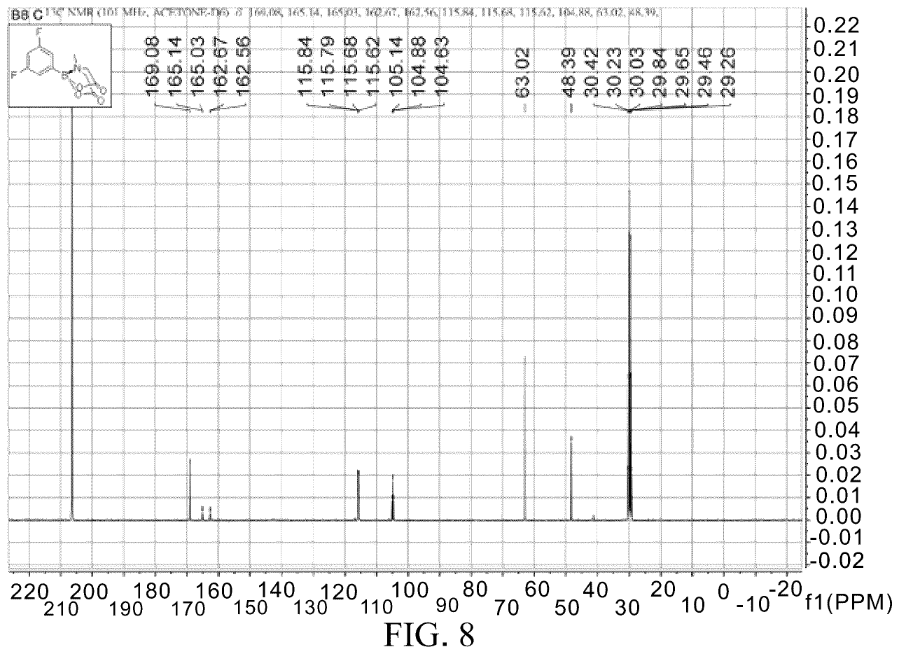

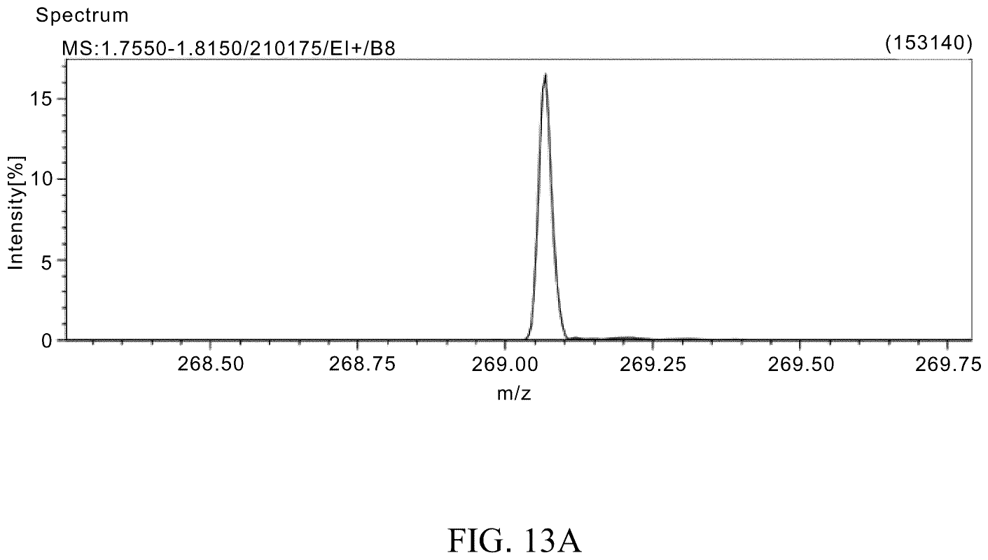

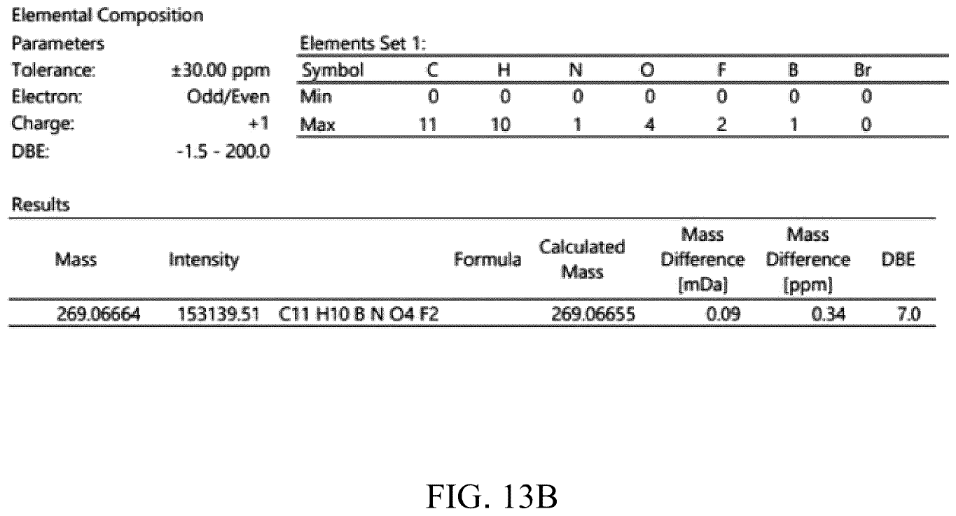

FIGS. 3, 8 and 13A, 13B.

### Synthesis Example 4 Synthesis of Additive (4)

3,5-difluorophenylboronic acid (1.0 equiv.) and N-methyliminodiacetic acid (3.0 equiv.) were placed in a round-bottom flask, 30 ml of a mixed solution of toluene/dimethylsulfoxide (1:0.1 by volume) was used as the reaction solvent, and the molecular sieve (molecular sieve 4 Å, CAS NO.70955-01-0) was added. Next, the mixture was heated under reflux at 120° C. and stirred for 18 hours. After the reaction was cooled to room temperature, the mixture was filtered through molecular sieves and extracted with ethyl acetate and aqueous sodium chloride solution for several times, and then anhydrous magnesium sulfate was added to remove water. After filtering off anhydrous magnesium sulfate, the initial product was obtained by concentration under reduced pressure (40° C. under vacuum). After about 2˜4 mL (for the consumption of milligram-level product) of acetone was added to the aforementioned initial product and then n-hexane was slowly dripped in, it can be observed that the junction of the two solutions appeared turbid. After standing for a period of time, it can be found that crystallization was precipitated. The solvent was removed by gravity filtration or pipette suction, and the final product additive (4) (DFDBD) can be obtained. The synthesis of additive (4) can be identified by NMR spectroscopy and HRMS mass spectroscopy. Please refer to

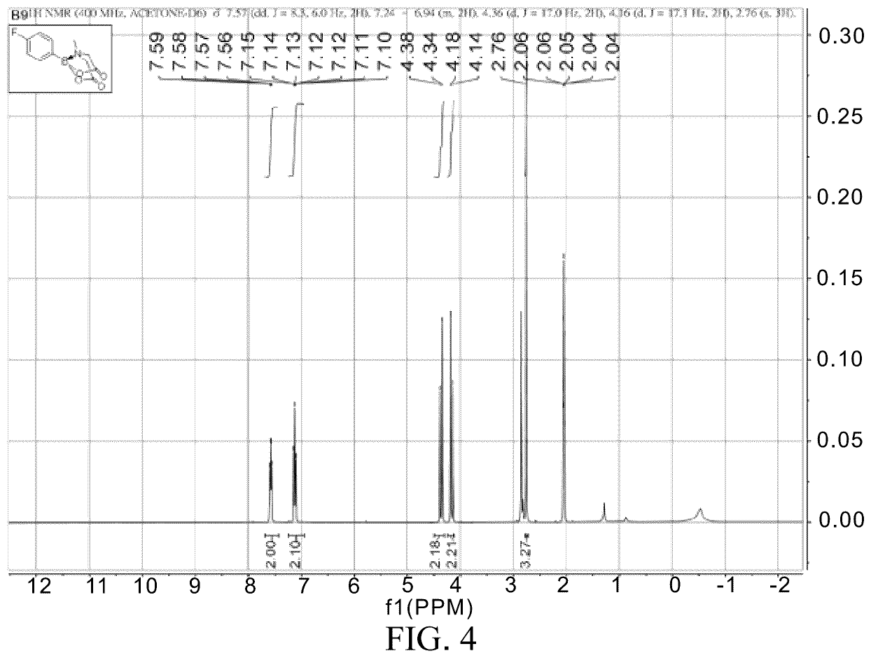

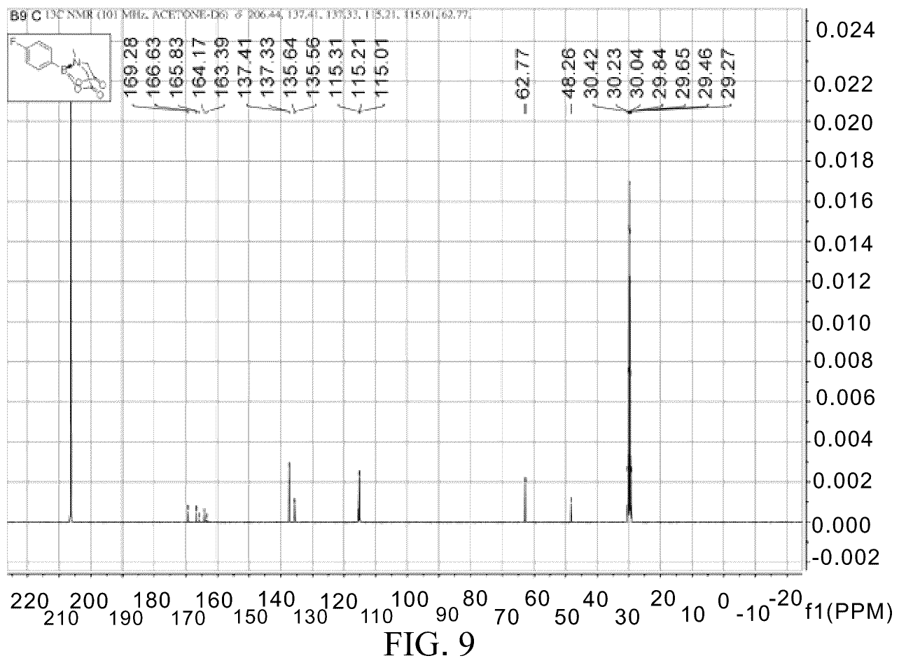

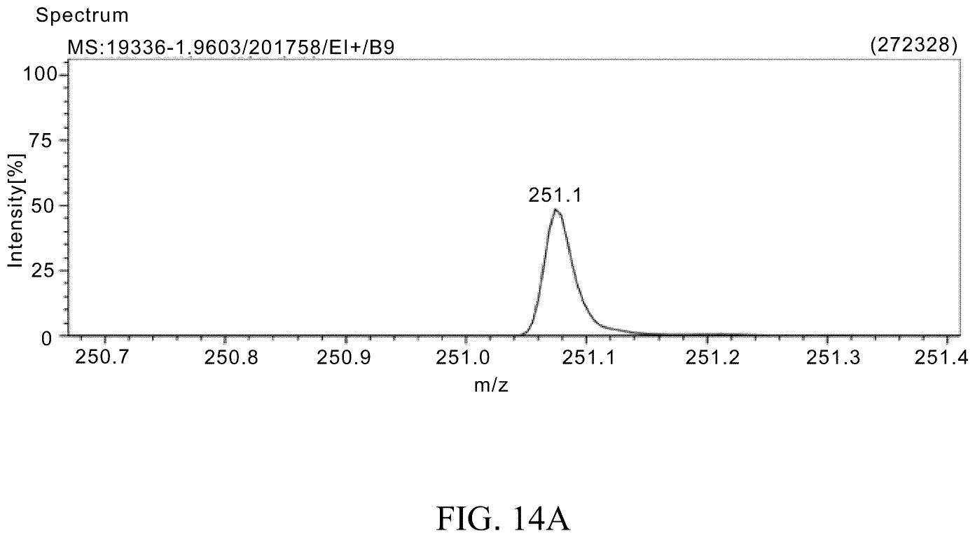

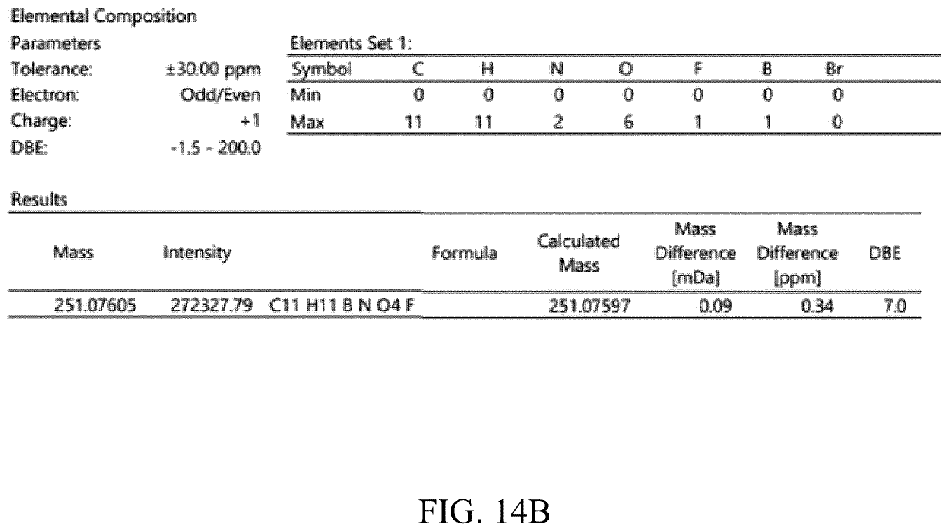

FIGS. 4, 9 and 14A, 14B.

### Synthesis Example 5 Synthesis of Additive (5)

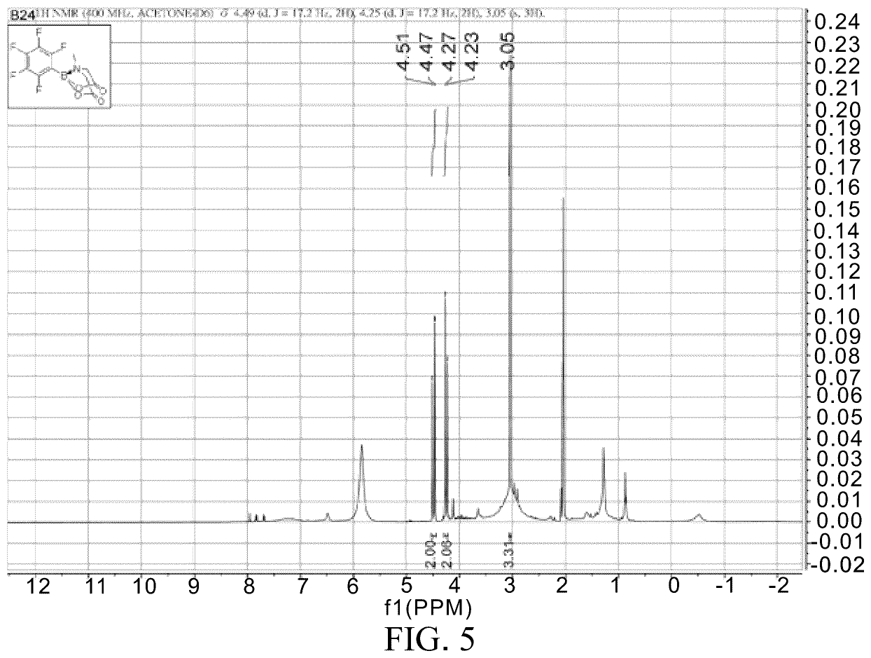

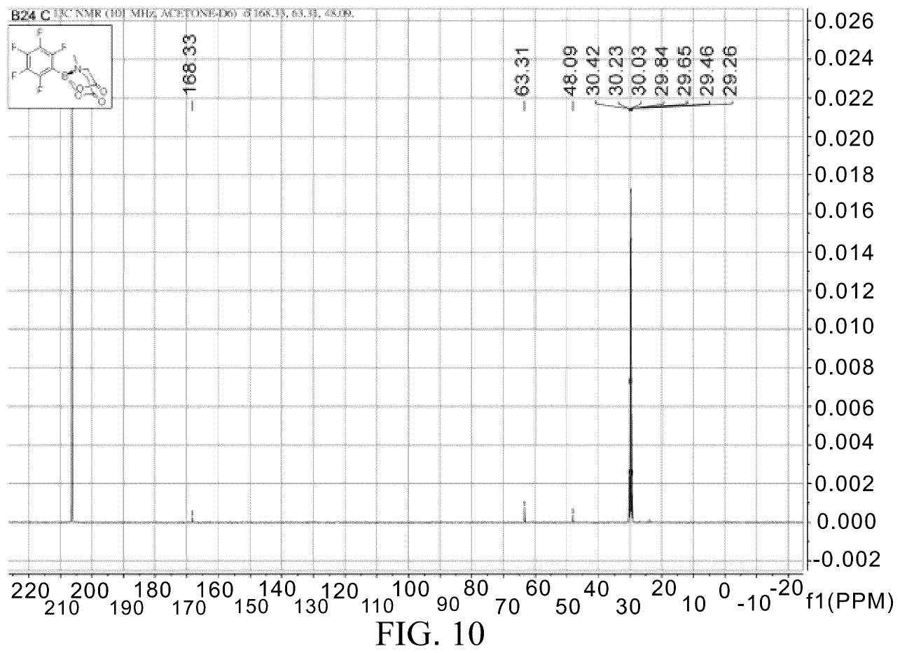

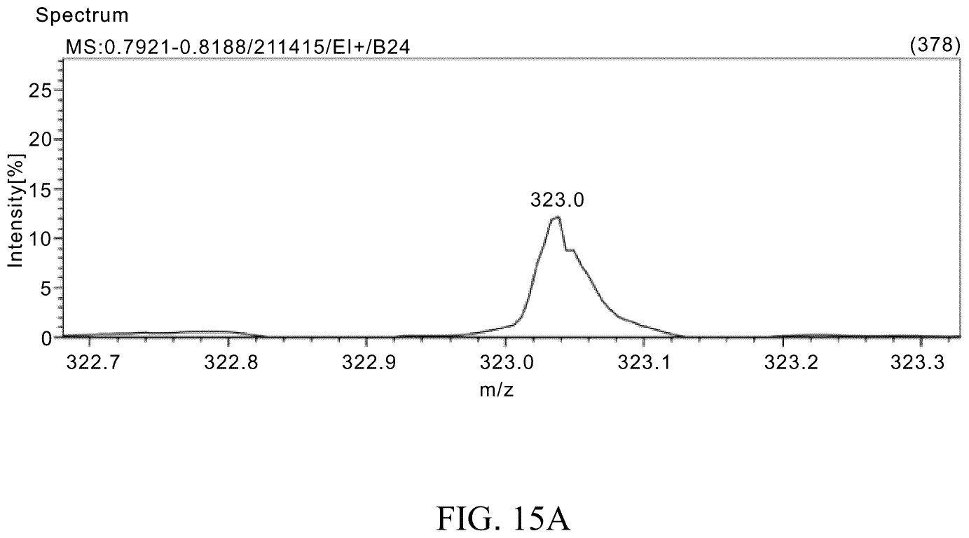

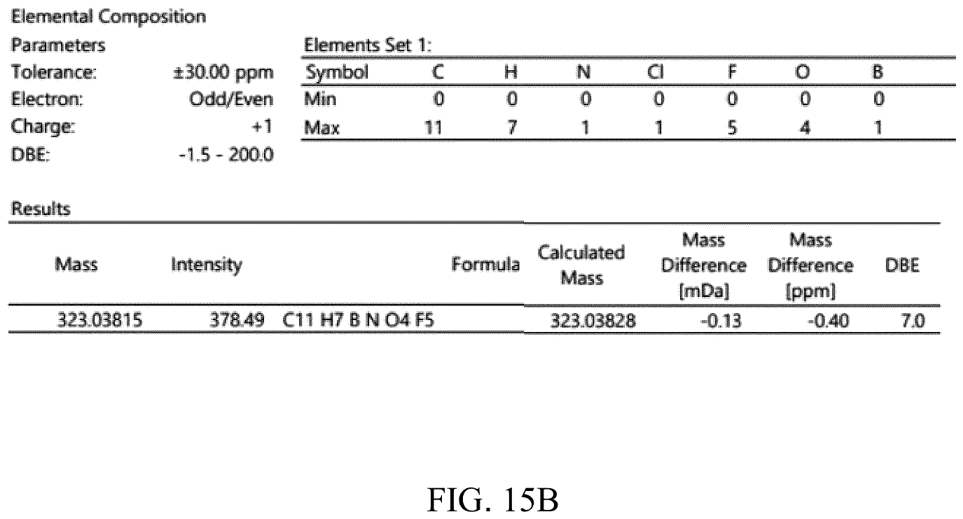

Pentafluorophenylboronic acid (1.0 equiv.) and 4-methylmorpholine-2,6-dione (or N-methyliminodiacetic anhydride) (3.0 equiv.) were placed in a round-bottom flask, and 5 ml of 1,4-dioxane was used as the reaction solvent. Next, the mixture was stirred at 7° C. for 24 hours. After the reaction was cooled to room temperature, the mixture was filtered through molecular sieves (molecular sieve 4 Å, CAS NO.70955-01-0) and extracted with ethyl acetate and aqueous sodium chloride solution for several times, and then anhydrous magnesium sulfate was added to remove water. After filtering off anhydrous magnesium sulfate, the initial product was obtained by concentration under reduced pressure (40° C. under vacuum). After about 2˜4 mL (for the consumption of milligram-level product) of acetone was added to the aforementioned initial product and then n-hexane was slowly dripped in, it can be observed that the junction of the two solutions appeared turbid. After standing for a period of time, it can be found that crystallization was precipitated. The solvent was removed by gravity filtration or pipette suction, and the final product additive (5) (PFDBD) can be obtained. The synthesis of additive (5) can be identified by NMR spectroscopy and HRMS mass spectroscopy. Please refer to FIGS. 5, 10 and 15A, 15B.

### Preparation of Electrolyte

The electrolytic of the present invention includes a lithium salt, a non-aqueous solvent and the electrolytic additive of the present invention. For the lithium salt, it may be any lithium salt that can be used as an electrolyte, for example, at least one selected from the group consisting of lithium hexafluorophosphate (LiPF₆), lithium tetrafluoroborate (LiBh₄), lithium bisoxalatoborate (LiBOB), lithium bis(trifluoromethylsulfonyl)amide (LiTFSI), lithium bisfluorosulfonylimide (LiFSI) and a combination thereof, preferably LiPF₆, but is not particularly limited thereto. Moreover, for the non-aqueous solvent, a cyclic carbonate-based solvent and a linear carbonate-based solvent may be exemplified.

The cyclic carbonate-based solvent is selected from the group consisting of ethylene carbonate (EC), propylene carbonate (PC), fluoroethylene carbonate

(FEC) and a combination thereof; and the linear carbonate-based solvent is selected from the group consisting of dimethyl carbonate (DMC), diethyl carbonate (DEC), ethyl methyl carbonate (EMC), 1,2-difluoroethylene carbonate (DFEC), bis(2,2,2-trifluoroethyl)carbonate (FEMC) and a combination thereof, which is not particularly limited.

Next, in terms of the weight percentage range of the electrolyte additive of the present invention in the electrolyte, it may be 0.001% to 80%, and preferably 0.01% to 3%.

### EXAMPLE 1

LiPF₆ was used as the electrolyte. As a solvent, ethyl carbonate with high dielectric constant (the relative dielectric constant being 89.8 for EC, 64.9 for PC and 2.82 for DEC) and diethyl carbonate with low viscosity (viscosity being 0.75 cp) were used, and the volume capacity ratio of the two was 1:1. The additive (1) of Synthesis Example 1 was used as the electrolyte additive. Next, the aforementioned electrolyte, solvent and electrolyte additive were mixed to obtain an electrolyte of LiPF₆ EC/DEC (v:v=1:1) with a volume molar concentration of 1M, wherein the weight percentage of the electrolyte additive in the electrolyte was 0.1 wt %, thereby obtaining the electrolyte of Example 1.

### EXAMPLE 2

The electrolyte of Example 2 was obtained in the same manner as that of Example 1, except that the additive (1) of Example 1 was changed to additive (2).

### EXAMPLE 3

The electrolyte of Example 3 was obtained in the same manner as that of Example 1, except that the additive (1) of Example 1 was changed to additive (3).

### EXAMPLE 4

The electrolyte of Example 4 was obtained in the same manner as that of Example 1, except that the additive (1) of Example 1 was changed to additive (4).

### EXAMPLE 5

The electrolyte of Example 5 was obtained in the same manner as that of Example 1, except that the additive (1) of Example 1 was changed to additive (5).

### EXAMPLE 6

LiPF₆ was used as the electrolyte. As a solvent, ethyl carbonate with high dielectric constant (the relative dielectric constant being 89.8 for EC, 64.9 for PC and 2.82 for DEC) and diethyl carbonate with low viscosity (viscosity being 0.75 cp) were used, and the volume capacity ratio of the two was 1:1. The additive (3) was used as the additive. Next, the aforementioned electrolyte, solvent and additive were mixed to obtain an electrolyte of LiPF₆ EC/DEC (v:v=1:1) with a volume molar concentration of 1.0 M, wherein the weight percentage of the additive in the electrolyte was 0.05 wt %, thereby obtaining the electrolyte of Example 6.

### EXAMPLE 7

LiPF₆ was used as the electrolyte. As a solvent, ethyl carbonate with high dielectric constant (the relative dielectric constant being 89.8 for EC, 64.9 for PC and 2.82 for DEC) and diethyl carbonate with low viscosity (viscosity being 0.75 cp) were used, and the volume capacity ratio of the two was 1:1. The additive (3) was used as the additive. Next, the aforementioned electrolyte, solvent and additive were mixed to obtain an electrolyte of LiPF₆ EC/DEC (v:v=1:1) with a volume molar concentration of 1.0 M, wherein the weight percentage of the additive in the electrolyte was 1 wt %, thereby obtaining the electrolyte of Example 7.

### EXAMPLE 8

LiPF₆ was used as the electrolyte. As a solvent, ethyl carbonate with high dielectric constant (the relative dielectric constant being 89.8 for EC, 64.9 for PC and 2.82 for DEC) and diethyl carbonate with low viscosity (viscosity being 0.75 cp) were used, and the volume capacity ratio of the two was 1:1. The additive (3) was used as the additive. Next, the aforementioned electrolyte, solvent and additive were mixed to obtain an electrolyte of LiPF₆ EC/DEC (v:v=1:1) with a volume molar concentration of 1.0 M, wherein the weight percentage of the additive in the electrolyte was 3.0 wt %, thereby obtaining the electrolyte of Example 8.

### Comparative Example 1

The electrolyte of Comparative Example 1 was obtained in the same manner as that of Example 1, except that the electrolyte additive of Example 1 was not added.

### Preparation of Electrode Piece

LiNi_{0.5}Mn_{1.5}O₄ as a positive electrode material, polyvinylidene fluoride (PVDF) as a binder and conductive carbon black (Super P) as an auxiliary conducting agent were mixed in a weight percentage of 90:5:5, and then an appropriate amount of N-methylpyrrolidone (NMP) as a solvent was added based on the total mixture weight until the mixed slurry exhibited thick but flowable and was free of particles. Specifically, the slurry and solvent were mixed in a ratio of about 1 g: 1.3 mL (total mixture weight: solvent) and became a uniform and thick slurry after stirring for 8 hours. Next, the mixed slurry was coated on the aluminum foil for batteries to form an electrode piece precursor, which was sent to an oven for drying. After drying, it was rolled at a rolling rate of 70% using an automatic rolling machine, so that the dried electrode piece precursor can be attached more tightly. After rolling, it was cut into electrode pieces with a diameter of 1.3 cm and send to the glove box for backup.

In addition, in the lithium-ion battery of the present invention, the positive electrode active material (positive electrode material) of the positive electrode can be selected from the group consisting of LiNiVO₄, LiNi_{0.5}Mn_{1.5}O₄, LiCrₓMn₂₋ₓO₄, LiNiPO₄ and a combination thereof; and the negative electrode active material (negatihdve electrode material) of the negative electrode can be at least one selected from an artificial graphite, a natural graphite and a silicon-carbon composite material composed of Si/SiOₓ (wherein 1<x<2) and graphite.

### Test Examples 1˜6

Before assembling the battery, first the aforementioned electrode piece was baked at 120° C. for 12 hours in a vacuum environment, then the electrode piece was put into the glove box, the lithium metal serving as the counter electrode (negative electrode), the separator, the electrolyte of Examples 1 to 5 and Comparative Example 1 and the electrode piece serving as the positive electrode were assembled into button-type half-cells respectively to obtain the button-type half-cells of Test Examples 1 to 6. Among them, Test Examples 1 to 5 used the electrolytes of Examples 1 to 5, and Test Example 6 used the electrolyte of Comparative Example 1. In addition, for the separator, conventional separators can be used, such as microporous films of polyethylene (PP)/polypropylene (PE) or PP/PE/PP; and the separator can also be a composite film formed of the aforementioned microporous film mixed with aluminum oxide (Al₂O₃) and silicon dioxide. In Test Examples 1 to 6, a 25 μm Celgard® 2500 polypropylene monolayer separator was used as the separator.

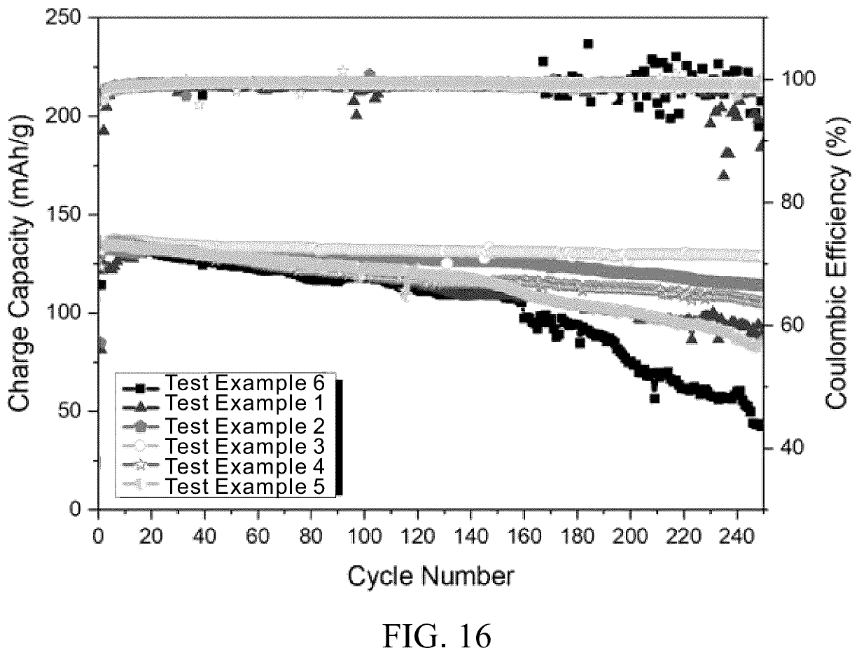

Next, electrical tests for the button-type half-cells of Test Examples 1 to 6 were conducted, and the results were organized in Table 2 and FIGS. 16 to 18. The aforementioned electrical test was a cycle life test of 250 charge-discharge cycles under the condition of charging and discharging at a current of 0.5 C (capacity).

TABLE 2

| | Test Example 6 | | | | | | | | | | | |
|---|---|---|---|---|---|---|---|---|---|---|---|---|
| | (Comparative | | Test Example 1 | | Test Example 2 | | Test Example 3 | | Test Example 4 | | Test Example 5 | |
| | Example 1) | | (Example 1) | | (Example 2) | | (Example 3) | | (Example 4) | | (Example 5) | |
| | capacity/ | | capacity/ | | capacity/ | | capacity/ | | capacity/ | | capacity/ | |
| capacity/ | efficiency | | efficiency | | efficiency | | efficiency | | efficiency | | efficiency | |
| efficiency | (mAh g⁻¹/%) | | (mAh g⁻¹/%) | | (mAh g⁻¹/%) | | (mAh g⁻¹/%) | | (mAh g⁻¹/%) | | (mAh g⁻¹/%) | |
| 1^{st} cycle | 136.5 | 37.74 | 121.9 | 56.07 | 130.6 | 57.19 | 132.5 | 64.86 | 123.3 | 71.85 | 132.5 | 57.19 |
| 5^{th} cycle | 134.6 | 98.65 | 122.2 | 98.61 | 132.6 | 98.85 | 137.0 | 98.71 | 135.8 | 97.95 | 137.0 | 98.85 |
| 100^{th} | 120.7 | 99.50 | 119.8 | 98.61 | 127.9 | 99.55 | 132.1 | 99.51 | 119.4 | 98.81 | 132.1 | 99.55 |
| cycle | | | | | | | | | | | | |
| 200^{th} | 93.9 | 99.25 | 100.4 | 99.09 | 120.2 | 99.46 | 129.9 | 99.47 | 112.5 | 98.56 | 129.9 | 99.46 |
| cycle | | | | | | | | | | | | |
| 250^{th} | 34.2 | 98.76 | 88.2 | 89.70 | 114.0 | 99.54 | 128.9 | 99.51 | 105.0 | 98.19 | 128.9 | 99.54 |
| cycle | | | | | | | | | | | | |
| capacity | 25% | | 72% | | 87% | | 97% | | 85% | | 47% | |
| retention | | | | | | | | | | | | |

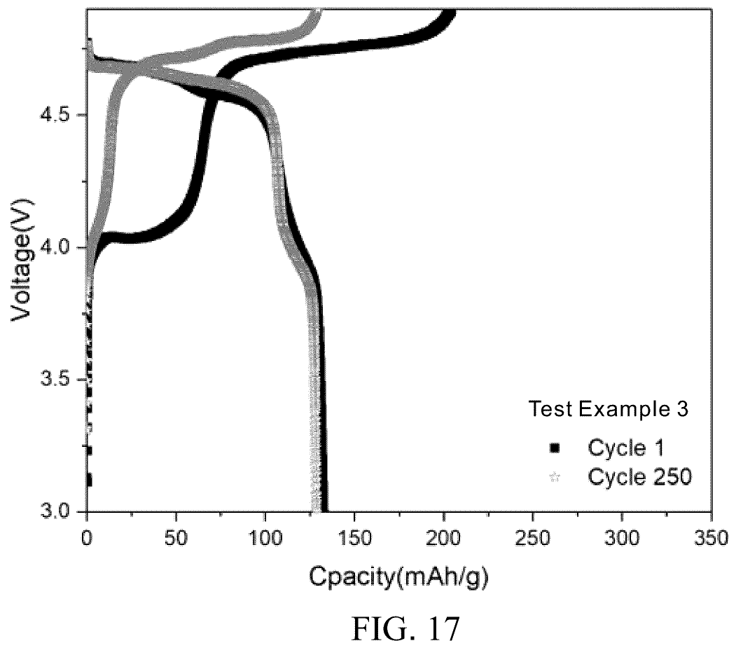

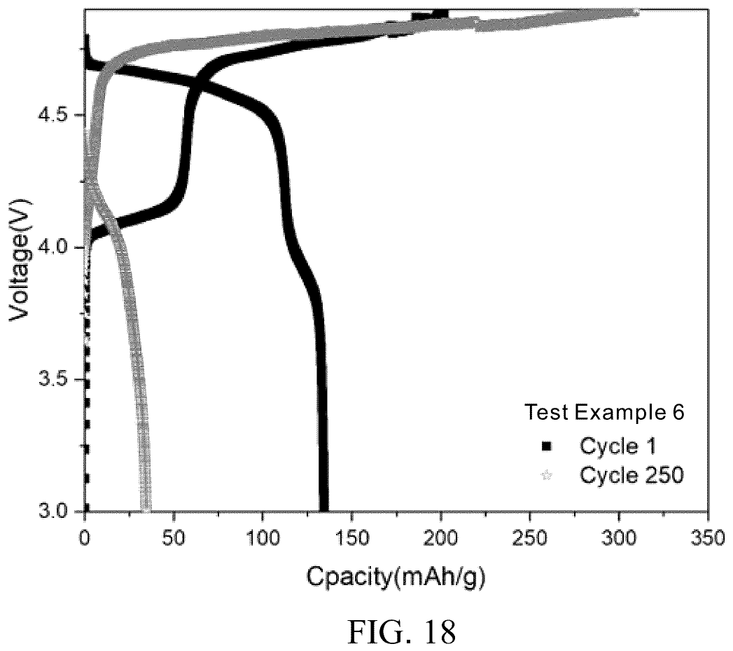

It can be seen from Table 2 and FIG. 16 that the capacities of Test Examples 1 to 5 (using the electrolytes of Examples 1 to 5) during the 200th cycle were all above than 100 mAh g⁻¹, which was greater than the capacity of 93.9 mAh g⁻¹ of Test Example 6 (using the electrolyte of Comparative Example 1). In addition, at the 250th cycle, the capacities of Test Examples 1 to 5 were all above 88 mAh g⁻¹. For example, referring to FIGS. 17 to 18, the capacity of Test Example 3 was 128.9 mAh g⁻¹, which was much larger than the capacity of 34.2 mAh g⁻¹ of Test Example 6.

In addition, in terms of capacity retention, Test Examples 1 to 5 were all more than 72%, far greater than the 25% of Test Example 6. From the results of Table 2 above, it can be observed that the electrolyte additive of the present invention has the effect of improving the cycle life of the battery.

### Test Examples 7˜11

Before assembling the battery, first the aforementioned electrode piece was baked at 120° C. for 12 hours in a vacuum environment, then the electrode piece was put into the glove box, the lithium metal serving as the counter electrode (negative electrode), the separator, the electrolytes of Examples 3 and 6 to 8 and Comparative Example 1 and the electrode piece serving as the positive electrode were assembled into button-type half-cells respectively to obtain the button-type half-cells of Test Examples 7 to 11. Among them, Test Example 7 used the electrolyte of Comparative Example 1, Test Example 8 used the electrolyte of Example 6, Test Example 9 used the electrolyte of Example 3, and Test Examples to 11 used the electrolytes of Examples 7 to 8. In addition, for the separator, conventional separators can be used, such as microporous films of polyethylene (PP)/polypropylene (PE) or PP/PE/PP. In Test Examples 7 to 11, a 25 μm Celgard® 2500 polypropylene monolayer separator was used.

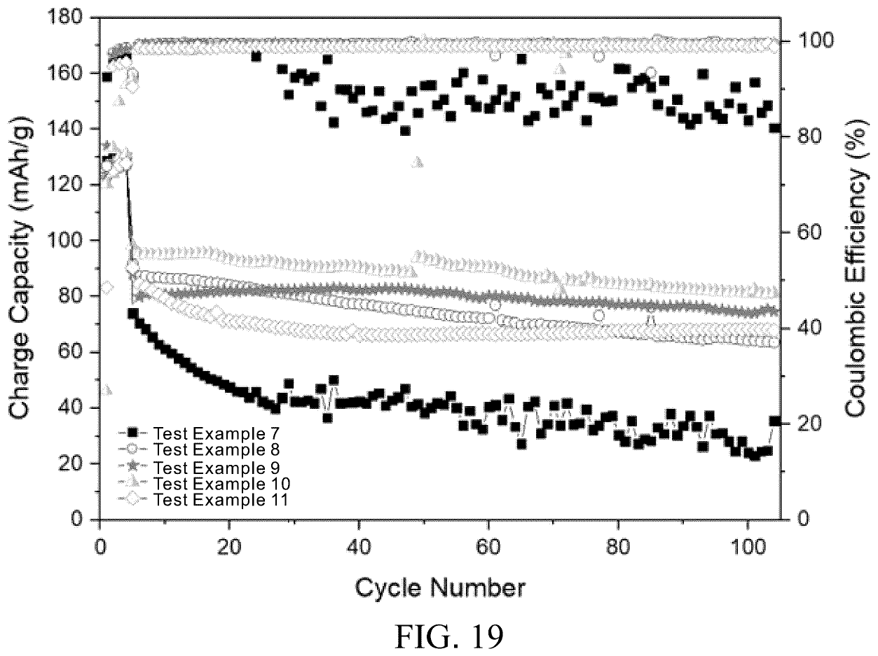

Next, electrical tests for the button-type half-cells of Test Examples 7 to 11 were conducted, and the results were organized in Table 3 and FIG. 19. The aforementioned electrical test was a cycle life test of 100 charge-discharge cycles under the condition of charging and discharging at a current of 3 C.

TABLE 3

| | Test Example 7 | | Test Example 8 | | Test Example 9 | | Test Example 10 | | Test Example 11 | |
|---|---|---|---|---|---|---|---|---|---|---|
| | (Comparative | | [0.05 wt % of | | [0.1 wt % of | | [1 wt % of | | [3 wt % of | |
| | Example 1) | | additive (3)] | | additive (3)] | | additive (3)] | | additive (3)] | |
| | capacity/ | | capacity/ | | capacity/ | | capacity/ | | capacity/ | |
| capacity/ | efficiency | | efficiency | | efficiency | | efficiency | | efficiency | |
| efficiency | (mAh g⁻¹/%) | | (mAh g⁻¹/%) | | (mAh g⁻¹/%) | | (mAh g⁻¹/%) | | (mAh g⁻¹/%) | |
| 1^{st} cycle | 74.1 | 92.7 | 91.6 | 93.2 | 78.4 | 92.0 | 98.4 | 92.3 | 90.4 | 90.5 |
| 100^{th} | 35.5 | 82.0 | 63.6 | 99.6 | 74.6 | 99.5 | 81.3 | 99.7 | 68 | 98.9 |
| cycle | | | | | | | | | | |
| capacity | 47% | | 69% | | 95% | | 82% | | 75% | |
| retention | | | | | | | | | | |

It can be seen from Table 3 and FIG. 19 that the capacities of Test Examples 8 to 11 during the 100th cycle were all above than 63.6 mAh g⁻¹, which was greater than the capacity of 35.5 mAh g⁻¹ of Test Example 7 (using the electrolyte of Comparative Example 1).

In addition, in terms of capacity retention, Test Examples 8 to 11 were all more than 69%, far greater than the 47% of Test Example 7. From the results of Table 3 above, it can be observed that the additive of the present invention has the effect of improving the cycle life of the battery if it is in the range of 0.01-3.0 wt % by weight in the electrolyte.

The present invention is not limited to the above-mentioned embodiments, various modifications can be made within the scope of the claims, and the embodiments obtained by appropriately combining the technical means disclosed in the different embodiments are also included within the technical scope of the present invention.

What is claimed is:

1. A lithium-ion battery electrolyte comprising:
a lithium salt, a non-aqueous solvent and an additive; wherein
the additive has a structure of formula (1) below: 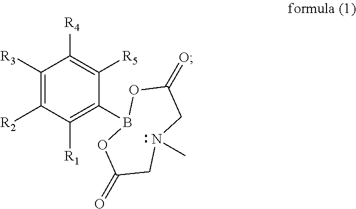
wherein, R₁, R₂, R₃, R₄ and R₅ are each independently selected from hydrogen, fluorine or chlorine.

2. The lithium-ion battery electrolyte of claim 1, wherein the formula (1) is

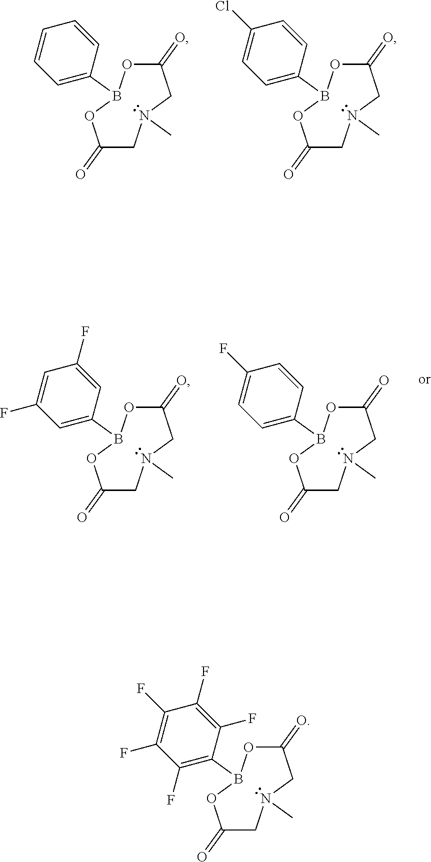 [SMILES: CN1CC(=O)OB(c2ccccc2)OC(=O)C1 ; CN1CC(=O)OB(c2ccc(Cl)cc2)OC(=O)C1 ; CN1CC(=O)OB(c2cc(F)cc(F)c2)OC(=O)C1 ; CN1CC(=O)OB(c2ccc(F)cc2)OC(=O)C1 ; "or" ; CN1CC(=O)OB(c2c(F)c(F)c(F)c(F)c2F)OC(=O)C1]

3. The lithium-ion battery electrolyte of claim 1, wherein a weight percentage of the additive in the lithium-ion battery electrolyte ranges from 0.01% to 3%.

4. The lithium-ion battery electrolyte of claim 1, wherein the lithium salt is selected from the group consisting of lithium hexafluorophosphate (LiPF₆), lithium tetrafluoroborate (LiBF₄), lithium bisoxalatoborate (LiBOB), lithium bis(trifluoromethylsulfonyl)amide (LiTFSI), lithium bisfluorosulfonylimide (LiFSI) and a combination thereof.

5. The lithium-ion battery electrolyte of claim 1, wherein the non-aqueous solvent includes a cyclic carbonate-based solvent and a linear carbonate-based solvent; the cyclic carbonate-based solvent is selected from the group consisting of ethylene carbonate (EC), propylene carbonate (PC), fluoroethylene carbonate (FEC) and a combination thereof; and the linear carbonate-based solvent is selected from the group consisting of dimethyl carbonate (DMC), diethyl carbonate (DEC), ethyl methyl carbonate (EMC), 1,2-difluoroethylene carbonate (DFEC), bis(2,2,2-trifluoroethyl)carbonate (FEMC) and a combination thereof.

6. A lithium-ion battery comprising:
a positive electrode;
a negative electrode;
a separator disposed between the positive electrode and the negative electrode; and
the lithium-ion battery electrolyte of claim 1.

7. The lithium-ion battery of claim 6, wherein a positive electrode active material of the positive electrode is selected from the group consisting of LiNiVO₄, LiNi_{0.5}Mn_{1.5}O₄, LiCrₓMn₂₋ₓO₄, LiNiPO₄ and a combination thereof; and a negative electrode active material of the negative electrode is at least one selected from an artificial graphite, a natural graphite and a silicon-carbon composite material composed of Si/SiOₓ (wherein 1<x<2) and graphite.
